(19) United States
(12) Patent Application Publication
(10) Pub. No.: US 2025/0201851 A1
(43) Pub. Date: Jun. 19, 2025

(54) ELECTRODE WITH PATTERNED CONDUCTIVE COATING

(71) Applicant: FORD GLOBAL TECHNOLOGIES, LLC, Dearborn, MI (US)

(72) Inventors: Insik JEON, Novi, MI (US); Jonghwan PARK, Ann Arbor, MI (US)

(21) Appl. No.: 18/539,073

(22) Filed: Dec. 13, 2023

(51) Int. Cl. H01M 4/62; H01M 4/04; H01M 4/66; H01M 4/75

(52) U.S. Cl. CPC H01M 4/625; H01M 4/0404; H01M 4/623; H01M 4/661; H01M 4/75

(57) ABSTRACT

An electrode includes a current collector, a pattern of conductive dots, each including an agglomeration of conductive particles and binder, embossed on the current collector, and a self-supporting solvent-free electrode film, including conductive particles, fibrilized polymeric binder, and active material, laminated onto the conductive dots and current collector.

### TECHNICAL FIELD

This disclosure relates to electrode structures for lithium-ion batteries.

### BACKGROUND

In the context of energy storage technologies, the fabrication of solvent-free dry electrodes for anodes and cathodes is an area of ongoing research.

### SUMMARY

An electrode with a current collector has a pattern of conductive dots embossed onto it. The conductive dots comprise an agglomeration of conductive particles and binder. Additionally, a self-supporting, solvent-free electrode film that includes conductive particles, a fibrilized polymeric binder, and active material is laminated onto the conductive dots and the current collector, forming a cohesive self-supporting electrode. In this electrode, the binder used in the conductive dots includes polyvinylidene fluoride. The binder in the electrode may be chosen from a selection including polytetrafluoroethylene, polyvinylidene fluoride, polyethylene, or carboxymethyl cellulose. The conductive particles used in the electrode may be carbon based. Specifically, these carbon-based conductive particles may be either carbon black or carbon nanotubes. The diameter of the conductive dots in the electrode may be designed to be less than 100 micrometers. More preferably, the diameter of these conductive dots may be less than 10 micrometers. The height of the conductive dots on the electrode may be less than 10 micrometers. Furthermore, the height of these conductive dots may be less than 5 micrometers. The current collector component of the electrode may be made of a metal foil. In particular, this metal foil used as the current collector may be made of copper. Alternatively, the current collector may be made of aluminum foil. The fibrilized polymeric binder used in the electrode may be polytetrafluoroethylene.

A method for creating an electrode involves laminating a solvent-free, self-supporting electrode film that includes conductive particles, a fibrilized polymeric binder, and active material onto a current collector. This collector is patterned with embossed conductive dots, each consisting of an agglomeration of conductive particles and binder, forming the self-supporting electrode. The method may also include dot-printing the embossed conductive dots onto the current collector. In this method, polytetrafluoroethylene may be used as the fibrilized polymeric binder.

An electrode having a solvent-free, self-supporting structure is formed with a solvent-free, self-supporting electrode film. This film includes conductive particles, a fibrilized polymeric binder, and active material, laminated onto conductive dots. These dots each contain an agglomeration of conductive particles, and a mix of fluorinated and non-fluorinated binders, embossed on a current collector. The fluorinated binder used in the electrode may be selected from a group including polytetrafluoroethylene, polyvinylidene fluoride, polyvinyl fluoride, polychlorotrifluoroethylene, perfluoroalkoxy polymer, ethylene tetrafluoroethylene, fluorinated propylene-methylene copolymer, and perfluoropolyether. The non-fluorinated binder in the electrode may be selected from options such as polyethylene, carboxymethyl cellulose, polymethyl methacrylate, and polyurethane. The conductive dots in the electrode may have a diameter of less than 10 micrometers and a height of less than 5 micrometers.

### BRIEF DESCRIPTION OF THE DRAWINGS

FIG. 1A is an exploded view of an electrode according to one embodiment;

FIG. 1B is a side view of an electrode according to one embodiment;

FIG. 2 is a schematic view of a conductive dot according to one embodiment;

FIG. 3 is a schematic view of a self-supporting solvent-free electrode film according to one embodiment; and

FIG. 4. is a flowchart of an assembly process according to one embodiment.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The fabrication of solvent-free dry electrodes typically involves mixing a polytetrafluoroethylene (PTFE) binder with conductive agents, such as carbon black or carbon nanotubes (CNTs), along with active electrode materials. The mixture is then hot-pressed to create cohesive, self-supporting electrode films, which are laminated onto current collectors. This method is valued for its potential to reduce the reliance on solvents in the production of electrodes.

A challenge encountered with the use of PTFE binders in this process is their low surface energy, which can lead to suboptimal adhesion with the current collectors. Insufficient adhesion may result in the layers of the electrode separating from the collectors, a condition that can increase the internal resistance within the cell and may contribute to a gradual decrease in capacity. Maintaining a stable and durable bond between the electrode film and the current collector may also maintain the performance and longevity of batteries produced with this method.

This disclosure relates to methods for electrode construction in energy storage devices, with a focus on the embossing technique to increase adhesion of the interface between the electrode active layer and current collector foils such as copper (Cu) or aluminum (Al). The embossed pattern consists of conductive dots, each formed from a mix of conductive particles and a specific binder, enhancing the active layer's adhesion to the collector. Patterned embossing, also known as dot-printing, is utilized to modify the surface area of the current collector, maintaining consistent adhesion with the electrode active layer.

The electrode composition is determined by blending conductive materials, such as carbon black and carbon nanotubes (CNTs), with various binders. These conductive materials are specifically chosen for their electrical conductivity properties. The choice of binders ranges from fluoro binders like polytetrafluoroethylene (PTFE), polyvinylidene fluoride (PVDF), to non-fluoro binders including polyethylene (PE) and carboxymethyl cellulose (CMC). The selection of a particular binder or combination thereof is dependent on the required properties of the final electrode such as mechanical stability and electrical conductivity. Each binder is selected based on its properties, such as polyvinylidene fluoride, which provides a balance between mechanical strength and chemical stability.

For coatings that utilize PTFE, PVDF is identified as a compatible embossing coating binder. PVDF is preferred due to its adhesion characteristics compared to other binders. This preference is based on the similarity in the chemical structure of PVDF to PTFE and its ability to adhere to the current collector substrates. PVDF tends to form a more stable bond with the current collector materials in comparison to PTFE, which can factor into the longevity and performance of the electrode.

The construction of the electrode is further defined by the physical characteristics of the conductive dots patterned onto the current collector. These dots are designed with diameters less than 100 micrometers, and preferably less than 10 micrometers, while their height is constrained to be less than 10 micrometers, ideally below 5 micrometers. These dots, each comprising an agglomeration of conductive particles and binder, are embossed onto the collector's surface to increase the electrode's active layer adherence. The conductive particles within these dots are typically carbon-based, offering favorable electrical properties. The dimensions of the conductive dots are selected to be 100 micrometers or less in diameter, and more preferably, less than 10 micrometers. Similarly, the height is constrained to a maximum of 10 micrometers, with an optimal height being 5 micrometers or less. This precision in dot structure may be helpful in maintaining uniformity across the electrode's surface.

The lamination process involves overlaying a solvent-free, self-supporting electrode film onto the patterned current collector. This film, comprising conductive particles, a fibrilized polymeric binder such as polytetrafluoroethylene, and active material, helps to form the self-supporting structure of the electrode. This film includes a mixture of conductive particles, a fibrilized polymeric binder, and an active material, which together form the self-supporting electrode. The choice of binder in the film complements the binder used in the conductive dots to maintain the integrity of the electrode structure. Binder options include both fluorinated types, which may share structural similarities with PTFE, and non-fluorinated types, each selected to fulfill specific roles within the electrode based on their unique properties.

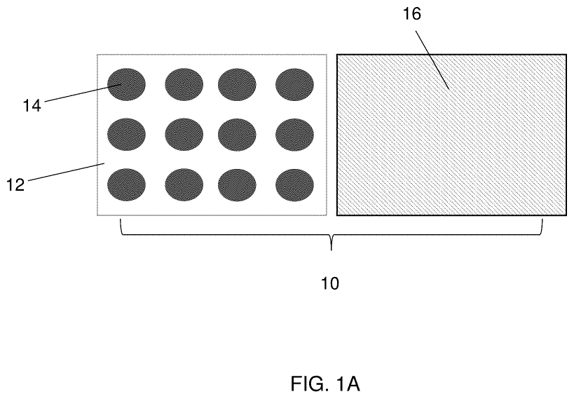

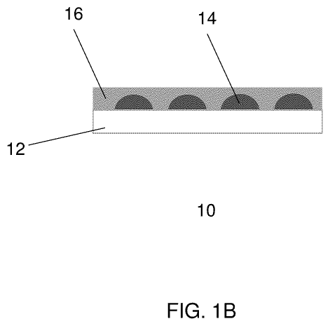

Referring now to FIG. 1A is an exploded view of an electrode 10, according to one or more embodiments. The electrode 10 has a current collector 12 made of metal foil, such as copper or aluminum foil, patterned with conductive dots 14. These dots are made of an agglomeration of conductive particles bound together with a binder and are embossed directly onto the surface of the current collector 12. A self-supporting, solvent-free electrode film 16 is laminated with the conductive dots 14 and the current collector 12, serving as the primary structural and conductive layer of the electrode 10. FIG. 1B is a side view of the electrode 10, the self-supporting solvent-free electrode film 16 laminated with the conductive dots 14 to the current collector 12.

The binder within the conductive dots 14 may be a fluorinated or non-fluorinated binder selected from a group including but not limited to polyvinylidene fluoride. These binders may provide a balance between mechanical strength and chemical stability. The conductive particles embedded within the dots may be selected for their electrical conductivity and may include materials like carbon black or carbon nanotubes. The dimensions of the conductive dots 14 are controlled, with diameters controlled to be less than 100 micrometers and more specifically less than 10 micrometers. The heights are controlled to be less than 10 micrometers and more preferably less than 5 micrometers.

The choice of material for the current collector 12 can vary, encompassing metals such as copper or aluminum, which are typically used in foil form to support the overlying electrode structure. Within the electrode film 16, is a fibrilized polymeric binder, which may include materials like polytetrafluoroethylene, utilized to increase durability of the electrode 10.

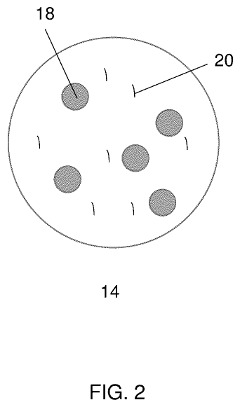

FIG. 2 is a schematic view of the conductive dot 14. The conductive dot 14 comprises an agglomeration of conductive particles 18 mixed with binder 20. The binder 20 can either solely be a fluorinated or a non-fluorinated binder or may be a mixture of one or more fluorinated or non-fluorinated binders. The selection of the binder is based on the required properties of the conductive dot 14, such as adhesion to the current collector and compatibility with the conductive particles 18. Fluorinated binders might include options like polytetrafluoroethylene, polyvinylidene fluoride, polyvinyl fluoride, polychlorotrifluoroethylene, perfluoro alkoxy polymer, ethylene tetrafluoroethylene, fluorinated propylene-methylene copolymer, and perfluoropolyether, while non-fluorinated binders could involve materials such as polyethylene, carboxymethyl cellulose, polymethyl methacrylate, and polyurethane. The conductive particles 16, potentially including carbon black or carbon nanotubes, are chosen for their ability to conduct electricity.

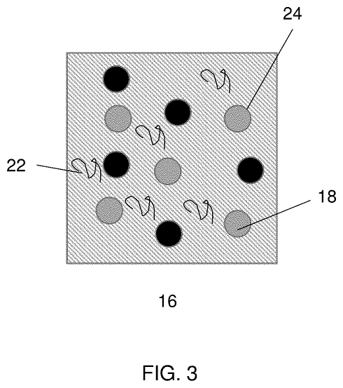

FIG. 3. is a schematic view of the self-supporting solvent-free electrode film 16. This film 16 comprises conductive particles 18, a fibrilized polymeric binder 22, and an active material 24. It is designed to be laminated onto the conductive dots 14 and the current collector 12, forming part of the electrode structure 10. The conductive particles 18 in the film may include carbon-based materials like carbon black or carbon nanotubes, which are used due to their electrical conductivity properties.

The fibrilized polymeric binder 22 in the film 16 could be a material such as polytetrafluoroethylene. This binder 22 is integrated with the conductive particles 18 and active material 24 to form the electrode film 16. The lamination process involves applying this film onto the patterned conductive dots 14 and the current collector 12, which may be composed of materials like copper or aluminum film. The overall assembly of the electrode 10 involves aligning and securing the embossed current collector 12 with the electrode film 16 contributing to the structure of the electrode.

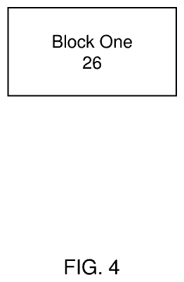

FIG. 4. is an illustration of a flowchart of an assembly process according to one embodiment. In Block One 26, a solvent-free self-supporting electrode film, including conductive particles, fibrilized polymeric binder, and active material is laminated onto a patterned current collector of embossed conductive dots. Each of the dots have an agglomeration of conductive particles and binder. After this lamination a solvent-free self-supporting electrode is formed. The conductive dots may be embossed onto the current collector by dot-printing. The fibrilized polymeric binder may be polytetrafluoroethylene.

The algorithms, methods, or processes disclosed or suggested herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials.

As previously described, the features of various embodiments may be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. An electrode comprising:
a current collector;
a pattern of conductive dots, each including an agglomeration of conductive particles and binder, embossed on the current collector; and
a self-supporting solvent-free electrode film, including conductive particles, fibrilized polymeric binder, and active material, laminated onto the conductive dots and current collector to form a self-supporting electrode.

2. The electrode of claim 1 wherein the binder includes polyvinylidene fluoride.

3. The electrode of claim 1 wherein the binder is selected from a group comprising polytetrafluoroethylene, polyvinylidene fluoride, polyethylene, or carboxymethyl cellulose.

4. The electrode of claim 1 wherein the conductive particles are carbon-based.

5. The electrode of claim 4 wherein the conductive particles are carbon black or carbon nanotubes.

6. The electrode of claim 1 wherein a diameter of the conductive dots is less than 100 μm.

7. The electrode of claim 6 wherein the diameter of the conductive dots is less than 10 μm.

8. The electrode of claim 1 wherein a height of the conductive dots is less than 10 μm.

9. The electrode of claim 8 wherein the height of the conductive dots is less than 5 μm.

10. The electrode of claim 1 wherein the current collector is a metal foil.

11. The electrode of claim 10 wherein the current collector is a copper foil.

12. The electrode of claim 11 wherein the current collector is an aluminum foil.

13. The electrode of claim 1 wherein the fibrilized polymeric binder is polytetrafluoroethylene.

14. A method comprising:
laminating a solvent-free self-supporting electrode film, including conductive particles, fibrilized polymeric binder, and active material, onto a patterned current collector of embossed conductive dots, each including an agglomeration of conductive particles and binder, to form a self-supporting electrode.

15. The method of claim 14, further comprising dot-printing the embossed conductive dots onto the current collector.

16. The method of claim 14 wherein the fibrilized polymeric binder is polytetrafluoroethylene.

17. A battery component comprising:
a solvent-free self-supporting electrode with a self-supporting solvent-free electrode film, including conductive particles, fibrilized polymeric binder, and active material, laminated onto conductive dots, each with an agglomeration of conductive particles, fluorinated binder, and non-fluorinated binder, embossed on a current collector.

18. The battery component of claim 17 wherein the fluorinated binder is selected from a group comprising polytetrafluoroethylene, polyvinylidene fluoride, polyvinyl fluoride, polychlorotrifluoroethylene, perfluoro alkoxy polymer, ethylene tetrafluoroethylene, fluorinated propylene-methylene copolymer, and perfluoropolyether.

19. The battery component of claim 17 wherein the non-fluorinated binder is selected from a group comprising polyethylene, carboxymethyl cellulose, polymethyl methacrylate, and polyurethane.

20. The battery component of claim 17 wherein a diameter of the conductive dots is less than 10 μm and a height of the conductive dots is less than 5 μm.
